(19) United States
(12) Patent Application Publication
(10) Pub. No.: US 2023/0362463 A1
(43) Pub. Date: Nov. 9, 2023

(54) LIGHT AND CAMERA SYSTEMS AND DEVICES AND METHODS FOR USING THE SAME

(71) Applicant: Robert Reynolds, Bradenton, FL (US)

(72) Inventor: Robert Reynolds, Bradenton, FL (US)

(21) Appl. No.: 18/142,960

(22) Filed: May 3, 2023

Related U.S. Application Data
(60) Provisional application No. 63/337,800, filed on May 3, 2022.

(51) Int. Cl. H04N 23/11; H04N 23/56; H04N 23/13

(52) U.S. Cl. CPC H04N 23/11; H04N 23/56; H04N 23/13

(57) ABSTRACT

Light and camera systems and devices and method for using the same. In an embodiment of a system, the system comprises a light source configured to emit light in a yellow-amber spectrum, and a camera for use when the light source is emitting light. In an embodiment of a system, the light source is configured directly emit the light, and wherein the yellow-amber spectrum comprises a spectrum range at or between 560 nm and 630 nm

### PRIORITY

The present application is related to, and claims the priority benefit of, U.S. Provisional Patent Application Ser. No. 63/337,800, filed May 3, 2022, the contents of which are incorporated herein directly and by reference in their entirety.

### BRIEF SUMMARY

In an exemplary embodiment of a system of the present disclosure, the system comprises a light source configured to directly emit light in a spectrum range at or between 560 nm and 630 nm (the yellow-amber spectrum), or indirectly emit light within said spectral range when the light is passed through a colored lens, and a camera for use when the light source is emitting light.

In an exemplary embodiment of a system of the present disclosure, wherein the light source comprises a colored lens, such that the light from the light source passes through the colored lens so that it is ultimately emitted at the spectrum range.

In an exemplary embodiment of a system of the present disclosure, the emitted light is visible by a human being.

In an exemplary embodiment of a system of the present disclosure, the emitted light facilitates improved camera operation.

In an exemplary embodiment of a system of the present disclosure, the camera is selected from the group consisting of a night vision camera, low-light camera sensors, a thermal camera, and a short-wave infrared (SWIR) camera.

The present disclosure includes disclosure of a system, comprising a light source configured to emit light in a yellow-amber spectrum, and a camera for use when the light source is emitting light.

The present disclosure includes disclosure of a system, wherein the light source is configured directly emit the light, and wherein the yellow-amber spectrum comprises a spectrum range at or between 560 nm and 630 nm.

The present disclosure includes disclosure of a system, wherein the light source is configured to indirectly emit the light within the yellow-amber spectrum when the light is passed through a colored lens.

The present disclosure includes disclosure of a system, wherein the yellow-amber spectrum comprises a spectrum range at or between 560 nm and 630 nm.

The present disclosure includes disclosure of a system, wherein the light source comprises a colored lens, such that the light from the light source passes through the colored lens so that it is ultimately emitted in the yellow-amber spectrum.

The present disclosure includes disclosure of a system, wherein the emitted light is in a visible range.

The present disclosure includes disclosure of a system, wherein the emitted light facilitates improved camera operation when the camera is operated in a direction where the light source is emitting the light.

The present disclosure includes disclosure of a system, wherein the camera comprises a night vision camera.

The present disclosure includes disclosure of a system, wherein the camera comprises a low-light camera sensor.

The present disclosure includes disclosure of a system, wherein the camera comprises a thermal camera.

The present disclosure includes disclosure of a system, wherein the camera comprises, and a short-wave infrared (SWIR) camera.

The present disclosure includes disclosure of a system, wherein the light source comprises amber light emitting diodes (LEDs).

The present disclosure includes disclosure of a device, comprising a light source configured to emit light in a yellow-amber spectrum, wherein when the light source is used in connection with a camera when the light source is emitting light, the emitted light facilitates improved camera operation when the camera is operated in a direction where the light source is emitting the light.

The present disclosure includes disclosure of a device, wherein the light source is configured directly emit the light, and wherein the yellow-amber spectrum comprises a spectrum range at or between 560 nm and 630 nm.

The present disclosure includes disclosure of a device, wherein the light source is configured to indirectly emit the light within the yellow-amber spectrum when the light is passed through a colored lens.

The present disclosure includes disclosure of a device, wherein the yellow-amber spectrum comprises a spectrum range at or between 560 nm and 630 nm.

The present disclosure includes disclosure of a device, wherein the light source comprises a colored lens, such that the light from the light source passes through the colored lens so that it is ultimately emitted in the yellow-amber spectrum.

The present disclosure includes disclosure of a method of facilitating vision under little to no ambient light conditions, the method comprising the step of operating the system of claim 1 so that the light source emits light in the yellow-amber spectrum, and so that the camera is operational when used in a direction of the emitted light.

The present disclosure includes disclosure of a method, wherein the step of operating is performed to improve navigation visibility of a watercraft having the system used in connection therewith.

The present disclosure includes disclosure of a method, wherein the step of operating does not comprise the operation of the light source or any other source of light that emits white, blue, green, or red light.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a system comprising a light source and a camera, according to an exemplary embodiment of the present disclosure; and

FIG. 2 shows a system comprising a light source and a camera, according to an additional exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

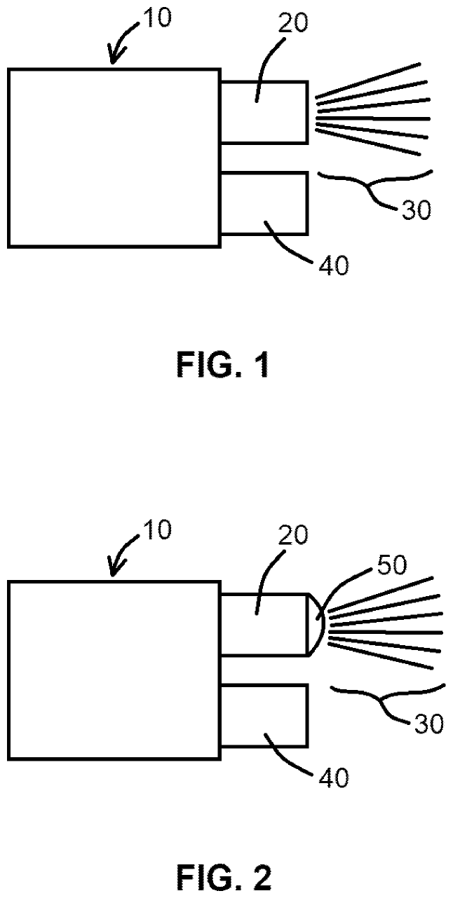

The present disclosure includes disclosure of systems configured to emit light and to capture images and/or video. In at least one embodiment of a system 10 of the present disclosure, and as shown in FIG. 1, the system 10 comprises one or more light sources 20 configured to emit light 30 in a spectrum range at or between 560 nm and 630 nm, namely light 30 in the yellow-amber spectrum. In various embodiments, systems 10 of the present disclosure comprise one or more cameras 40 for operation/use when the one or more light sources is/are emitting light 30. In at least one embodiment, the system comprises a single unit comprising the one or more light sources 20 and the one or more cameras 40, as shown in FIGS. 1 and 2. Light sources 20, as referenced herein, can be configured to emit light within the above referenced spectral range originally, such as, for example, comprising amber LEDs configured to emit light in a focused yellow-amber or amber color without a colored lens, such as described below. Light sources 20 of the present disclosure can include any light source configured to emit a peak wavelength within the spectral range listed above, regardless of whether or not said light passes through a colored lens or not.

In various embodiments, and as referenced above, the light source 20 can comprise a colored lens 50, such as shown in FIG. 2, such that the light 30 from the light source 20 passes through the colored lens 50 so that it is ultimately emitted at the spectrum range at or between 560 nm and 630 nm. In various embodiments, the emitted light 30 is visible by a human being.

In various system 10 embodiments of the present disclosure, the emitted light 30 facilitates improved camera 40 operation, such that the camera 40 is able to capture images/and or video with more clarity, definition, brightness, contrast, etc., than the camera 40 would be able to capture when not used in connection with the emitted light. Cameras 40 of the present disclosure can include, but are not limited to, night vision cameras, low-light camera sensors, thermal cameras, and a short-wave infrared (SWIR) camera.

Systems 10 of the present disclosure are particularly useful in connection with forward navigation of watercraft, vehicles, and the like when there is little to no ambient light. The emitted yellow-amber light 30 provides the navigator with improved visibility as compared to a traditional “white” light. Furthermore, when coupled with a camera 40, the system 10 can improve the overall operational results of the camera 40 due to an improved field of vision caused by the emitted yellow-amber light 30.

In various system 10 embodiments, said system 10 comprises one or more light sources 20 configured to emit light 30 in a spectrum range at or between 560 nm and 630 nm, namely light 30 in the yellow-amber spectrum, but without a camera 40. In such an embodiment, system 10 is operable to improve forward navigation visibility, such as when navigating a boat over dark waters, due to emission of yellow-amber light 30 from the one or more light sources 20. As such, systems 10 of the present disclosure are configured to emit yellow-amber light 30 from one or more light sources 20 so to improve visibility in the dark when navigating a watercraft, vehicle, or other means of transportation. In view of the same, the present disclosure includes disclosure of systems 10, and components thereof, configured for use for forward facing boat navigation. Noting that Coast Guard rules prohibit the use of white, blue, green, and red forward-facing navigation lights, systems 10 of the present disclosure configured to emit yellow-amber light 30 (via one or more light sources 20) in connection with use of a camera (40) are an ideal solution for low-light and dark navigation.

While various embodiments of light and camera systems and devices and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system, comprising:
a light source configured to emit light in a yellow-amber spectrum; and
a camera for use when the light source is emitting light.

2. The system of claim 1, wherein the light source is configured directly emit the light, and wherein the yellow-amber spectrum comprises a spectrum range at or between 560 nm and 630 nm.

3. The system of claim 1, wherein the light source is configured to indirectly emit the light within the yellow-amber spectrum when the light is passed through a colored lens.

4. The system of claim 3, wherein the yellow-amber spectrum comprises a spectrum range at or between 560 nm and 630 nm.

5. The system of claim 1, wherein the light source comprises a colored lens, such that the light from the light source passes through the colored lens so that it is ultimately emitted in the yellow-amber spectrum.

6. The system of claim 1, wherein the emitted light is in a visible range.

7. The system of claim 1, wherein the emitted light facilitates improved camera operation when the camera is operated in a direction where the light source is emitting the light.

8. The system of claim 1, wherein the camera comprises a night vision camera.

9. The system of claim 1, wherein the camera comprises a low-light camera sensor.

10. The system of claim 1, wherein the camera comprises a thermal camera.

11. The system of claim 1, wherein the camera comprises, and a short-wave infrared (SWIR) camera.

12. The system of claim 1, wherein the light source comprises amber light emitting diodes (LEDs).

13. A device, comprising:
a light source configured to emit light in a yellow-amber spectrum;
wherein when the light source is used in connection with a camera when the light source is emitting light, the emitted light facilitates improved camera operation when the camera is operated in a direction where the light source is emitting the light.

14. The device of claim 13, wherein the light source is configured directly emit the light, and wherein the yellow-amber spectrum comprises a spectrum range at or between 560 nm and 630 nm.

15. The device of claim 13, wherein the light source is configured to indirectly emit the light within the yellow-amber spectrum when the light is passed through a colored lens.

16. The device of claim 15, wherein the yellow-amber spectrum comprises a spectrum range at or between 560 nm and 630 nm.

17. The device of claim 13, wherein the light source comprises a colored lens, such that the light from the light source passes through the colored lens so that it is ultimately emitted in the yellow-amber spectrum.

18. A method of facilitating vision under little to no ambient light conditions, the method comprising the step of:
operating the system of claim 1 so that the light source emits light in the yellow-amber spectrum, and so that the camera is operational when used in a direction of the emitted light.

19. The method of claim 18, wherein the step of operating is performed to improve navigation visibility of a watercraft having the system used in connection therewith.

20. The method of claim 18, wherein the step of operating does not comprise the operation of the light source or any other source of light that emits white, blue, green, or red light.
